(19) United States
(12) Patent Application Publication
(10) Pub. No.: US 2017/0154329 A1
(43) Pub. Date: Jun. 1, 2017

(54) SECURE TRANSACTION SYSTEM AND VIRTUAL WALLET

(71) Applicants: Sajan BABU, Bangalore (IN); Sreeraj SREEDHARAKURUP, (US)

(72) Inventors: Sajan BABU, Bangalore (IN); Sreeraj SREEDHARAKURUP, Bangalore (IN)

(21) Appl. No.: 14/443,674

(22) PCT Filed: Nov. 21, 2013
(86) PCT No.: PCT/IB2013/060296

§ 371 Date: May 19, 2015

(30) Foreign Application Priority Data
Nov. 23, 2012 (IN) 4898/CHE/2012
Nov. 12, 2013 (IN) 5130/CHE/2013

(51) Int. Cl. G06Q 20/36; G06Q 20/40; G06Q 20/38

(52) U.S. Cl. CPC G06Q 20/3674; G06Q 20/382; G06Q 20/4012

(57) ABSTRACT

The present invention relates to a system and method that enables secure transactions using mobile phones/computing devices as a virtual wallet/transaction terminal system to do financial/other transactions at any transaction terminal and on the internet without producing/using physical credit/debit or any other payment cards/devices. The transaction is effected by using the information and associated processing hardware and software stored in the user devices that generates unique, encrypted, time limited authentication data capable of being transmitted using insecure means. The authorization data is transferred to issuing authority system directly or through a transaction terminal system using a coded image to perform the required authentication, authorization and the transaction itself.

### TECHNICAL FIELD OF THE INVENTION

This invention relates to a system and method that enables the use of mobile phones and/or other computing devices for transaction processing at a transaction terminal as well as on the internet eliminating the need to produce/use physical credit/debit cards of all kinds as well as various applications of cards such as identity/membership/authentication/other cards.

### BACKGROUND OF THE INVENTION

Today, a lot of commercial and non-commercial transactions happen using the physical swiping of one or many of the multiple types of payment and other cards issued to the user by various organizations. There are also access control cards in existence such as those with RFID tags that need to be physically produced and placed near the appropriate sensor for using it. But, this has given rise to new problems—the difficulty to carry multiple cards physically in a wallet and the risk of theft, misplacement and misuse associated with it. Mobile technology has advanced to include applications catering to all walks of life and touched upon almost all activities of the individuals and have saved a lot of time and effort for the user. It is important that such technology reaches the end user transaction scenarios and help the user address the above mentioned concerns or problems. Such cards are also used to authenticate membership to all kinds of institutions such as clubs, store chains, organizations, parking lots etc and this invention is relevant and applicable to all such scenarios where a card is used, whether swiped on a card reader or not.

Even after so much advancement in the mobile technology, a simple solution to use a mobile phone and similar computing devices as a wallet has not been arrived till now. There have been multiple attempts to address this problem using various mobile technology solutions. But these solutions require new type of hardware for mobile phones to provide the facility of mobile wallet payment to the user and/or lack requisite security against misuse.

Currently there are applications that creates wallet using an intermediary between the organization and the user to function as a front end for the wallet application. This brings in security of the data and the credibility of the intermediary a prime factor on identity and security risk. There are some other applications that operates through the internet cloud and functions only through the help of internet. These types of applications bring in the requirement for internet connection on the mobile phone/computing device at the time of transaction, every time.

Hence there is a need of a system and method in which payment and all other kinds of transactions can be performed in almost all types of existing mobile phones and other computing devices (with or without internet access) in a safe and secure manner and also without having any intermediary between the organization (example: credit card issuer) and the user.

In addition to the above, internet transactions today requires the user to enter the credit/debit/other card details on each website and on each transaction and also perform a time consuming password entry at the bank's website to securely complete the transaction. The card details get entered in many websites causing a security risk of misuse of such information by rouge websites or dishonest individuals having access to the entered information. This invention provides an innovative solution to this problem too, that simplifies the transaction while providing highly secure operation. The invention also provides an innovative solution to allow third parties to perform authorized transactions on behalf of the owner of the virtual card. For example, such a scenario can be used to make payments for purchases made by spouse, children, friends or an agent acting on behalf of the user.

### SUMMARY OF THE INVENTION

The present invention provides a simplified summary of some embodiments bringing out a basic understanding of aspects which are described in detail in later sections. This summary is not extensive and is not intended to identify all critical aspects or define the scope of the present innovation. It is presented with the sole purpose of giving a simple overview of some elements of the subject matter as a prelude to a more detailed presentation later.

In brief terms, embodiments relates to a system and method that enable user transactions using commercially available mobile phones and other computing devices (user devices) at any transaction terminal (example, Point of Sale (PoS), Automatic Teller Machine (ATM)) without the need to use physical credit/debit cards or any other such cards/devices and without the need for special hardware than what is normally available in most present day user devices. Embodiments envisage using the virtual card information stored in the user devices in an encrypted form and associated processing hardware and software to perform the transactions. In addition to financial transactions, embodiments enable implementation of other virtual membership cards such as identity cards, access control cards issued by various transaction service providers (TSPs)/issuing authorities (TSPs or issuing authorities are institutions or organizations such as banks, credit card companies or any entity with authority or rights to provide the hardware and software infrastructure that may be required for performing the transaction) is stored in the computing device as a Deployment Virtual Card Bundle (DVCB) that is secured by encryption using a hierarchy of passwords and organized in a user defined manner for easily accessing a particular card. At the time of performing the transaction, the user opens the virtual wallet system application (VWSA) in the user device, the user further authenticates by typing a password and selects the card that is to be used for the transaction. The selected card information is displayed on the screen of the user device as a coded image that contains all the information required to perform the transaction. The screen of the user device is acquired by a transaction terminal system (TTS) that acquires the coded image, decodes it and transfers it part to the TSP's Issuing Authority System (IAS) for performing the transaction.

Embodiments also enables security enhancement whereby the coded image is dynamically generated by the VWSA and is valid only for a short duration after it is generated within which time the transaction must be completed. Once a transaction is completed, additional security measures to prevent re-use of the image code is also enabled.

The embodiments can be extended to the user operations for any other types of card processing scenarios and also to include all types of visual coding/imaging techniques that can capture and pass on the user card information to the transaction terminal via the screen of the user device.

The invention includes the usage of the same concept for simplifying and securing internet transactions. The invention also includes a technique to allow a third party to complete a transaction over the internet or at a transaction terminal on behalf of the virtual card owner.

### BRIEF DESCRIPTION OF THE DRAWINGS

FIG. 1 illustrates a block diagram of an embodiment of the transaction system for allowing the end user to perform secure transaction using virtual wallet at a transaction terminal.

FIG. 2 illustrates a block diagram of an embodiment of the transaction system for allowing the end user to perform secure online transaction using virtual wallet.

FIG. 3 illustrates a high level block diagram of an embodiment of the transaction system for allowing the end user to perform secure transaction using virtual wallet.

FIG. 4 illustrates a block diagram of an embodiment of the issuing authority system.

FIG. 5 illustrates a block diagram of an embodiment of the processing system that is a part of the issuing authority system, virtual wallet system and transaction terminal system.

FIG. 6 illustrates a block diagram of an embodiment of the data communication system that is a part of the issuing authority system, virtual wallet system and transaction terminal system.

FIG. 7A illustrates a flow chart of an embodiment of the issuing authority system for generating a secure user account data file (SUADF) (or Deployment Virtual Card Bundle (DVCB)).

FIG. 7B illustrates a flow chart of an embodiment of the virtual wallet system for generating a transaction authentication secure data sequence (TASDS) (or Secured Transaction Data Frame (STDF)).

FIG. 7C illustrates a flow chart of an embodiment of the issuing authority system for generating a secure irreproducible user authentication code (UAC) as well as securing the user specific data.

FIG. 7D illustrates a flow chart of an embodiment of the issuing authority system for authenticating and performing a transaction.

FIG. 7E illustrates a flow chart of an embodiment of the issuing authority system for validating the transaction authentication data sequence.

FIG. 8A illustrates an activity diagram of an embodiment of the transaction system wherein the user sets up his virtual wallet system in a computing device.

FIG. 8B illustrates an activity diagram of an embodiment of the transaction system wherein the user uses the virtual wallet system for performing a transaction.

### DETAILED DESCRIPTION OF THE INVENTION

Embodiments of the claimed subject matter are described with reference to the drawings. There are numerous specific details set forth in the following description to provide a good understanding of the embodiments. The claimed subject matter may be practiced without these specific details. The drawings also show instances of well known structures in block diagram form to simplify the illustration and for the sake of completeness while describing the embodiment.

The term “user” used herein represents any user of an issuing authority system and can be the user of a virtual wallet system or the user (owner/operator) of a transaction terminal system. The term end user used herein refers to the user of a virtual wallet system who authenticates and authorizes a transaction.

The term “computing device” used herein represents any mobile telephone, a personal digital assistant, a handheld computer, a notebook computer, a tablet computer, a personal computer, a laptop computer, a generic purpose computer, a specific purpose computer or any computing device that provides the processing capability, communication capability, data storage, and other peripheral interfaces for input/output as required by components or sub-systems of an embodiment. Both virtual wallet system and transaction terminal system are abstracted as computing devices. But an “end user computing device” as used herein is used to refer to a virtual wallet system.

The term “transfer by any means” used herein in the context of data transfer includes all means of transferring the data including but not limited to electronic network communication, printed material, email, SMS, MMS, image codes (such as bar codes, QR codes etc), physical storage media (hard disks, memory cards etc.), wireless communication systems etc., or a combination of such techniques.

The term “third party” used herein represents any party authorized by the end user of the present invention to perform transactions on behalf of the end user.

The term “communication channel” used herein represents any telecommunication network, mobile network, the internet or any means of transferring data as defined above for performing one way or two way communications.

Embodiments includes methods and systems to enable secure transactions using commercially available mobile phones and other computing devices (user devices) at any transaction terminal (TTML) (example, Point of Sale (PoS), Automatic Teller Machine (ATM)) as well as on the internet without the need to use physical credit/debit cards or any other such cards/devices and without the need for special hardware other than what is normally available in most of the present day user devices. In another embodiment, user devices can also be configured to work as a transaction terminal system so as to enable small merchants, taxi drivers, door to door sales persons etc, to accept payment transactions on their computing devices. This invention envisages using the virtual card information stored in the user devices in an encrypted form and associated processing systems to perform the transactions. In addition to financial transactions, embodiments also covers the use of the innovation for membership cards, identity cards, access control cards etc., without the need for physical cards. Some embodiments include a technique to allow a third party to complete a transaction over the internet, or at a transaction terminal using a portable user device on behalf of the virtual card owner.

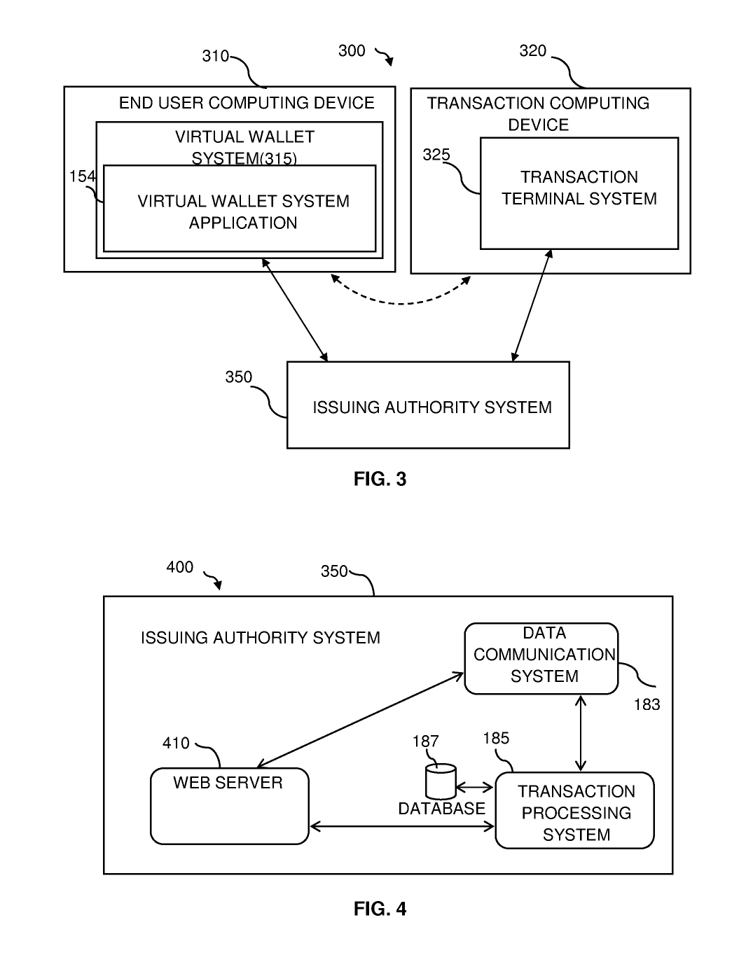

### An Example First Embodiment (FIG. 3, Supporting Figures)—Structure

FIG. 3 illustrates a high level block diagram of an embodiment of the transaction system for allowing the end user to perform secure transaction using virtual wallet. The system (300) of the embodiment comprises an issuing authority system (IAS) (350) that is operated by a transaction service provider (TSP), wherein the TSPs are organizations such as banks, credit card providers or any such entity with authority to issue and manage virtual equivalents of physical cards/coupons etc. The IAS (350) is connected using a communication network to a transaction computing device (320) that integrates functions of the transaction terminal system (TTS) (325). The IAS is also connected using a communication network to an end user computing device (310) that integrates function of the virtual wallet system (VWS) (315). The VWS (315) comprises of virtual wallet system application (VWSA) (154) that customizes the computing device for use as a virtual wallet. The interconnections mentioned permit transfer of data between the IAS (350) and the TTS (325) as well as between the IAS (350) and the VWS (315). For understanding the structure of the embodiments, the detailed structures of some blocks are discussed below before explaining the operation.

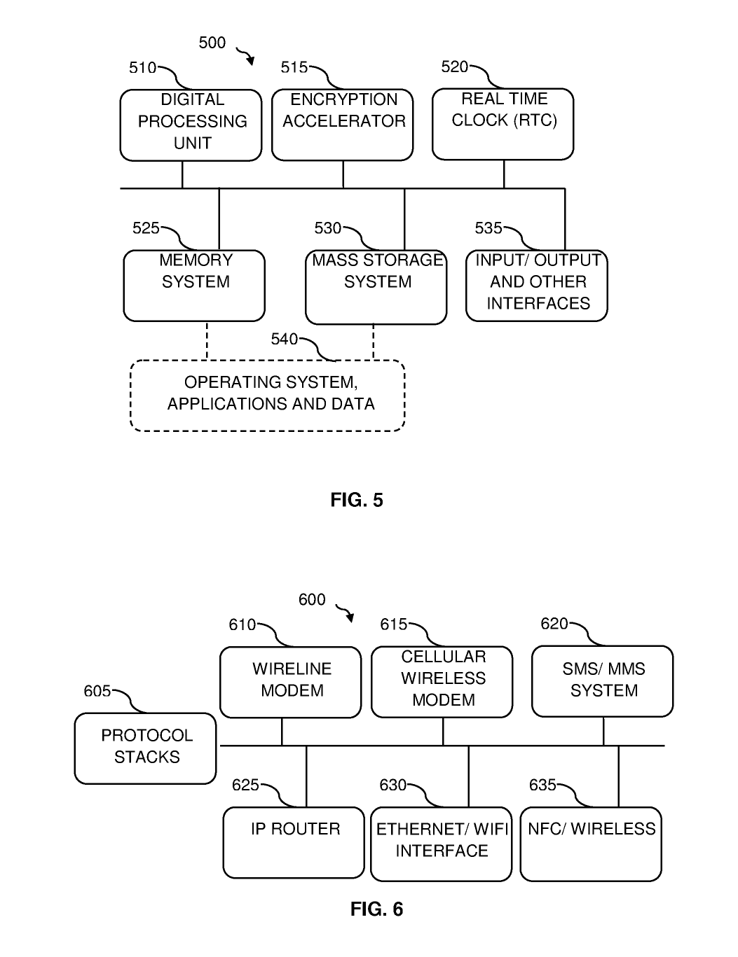

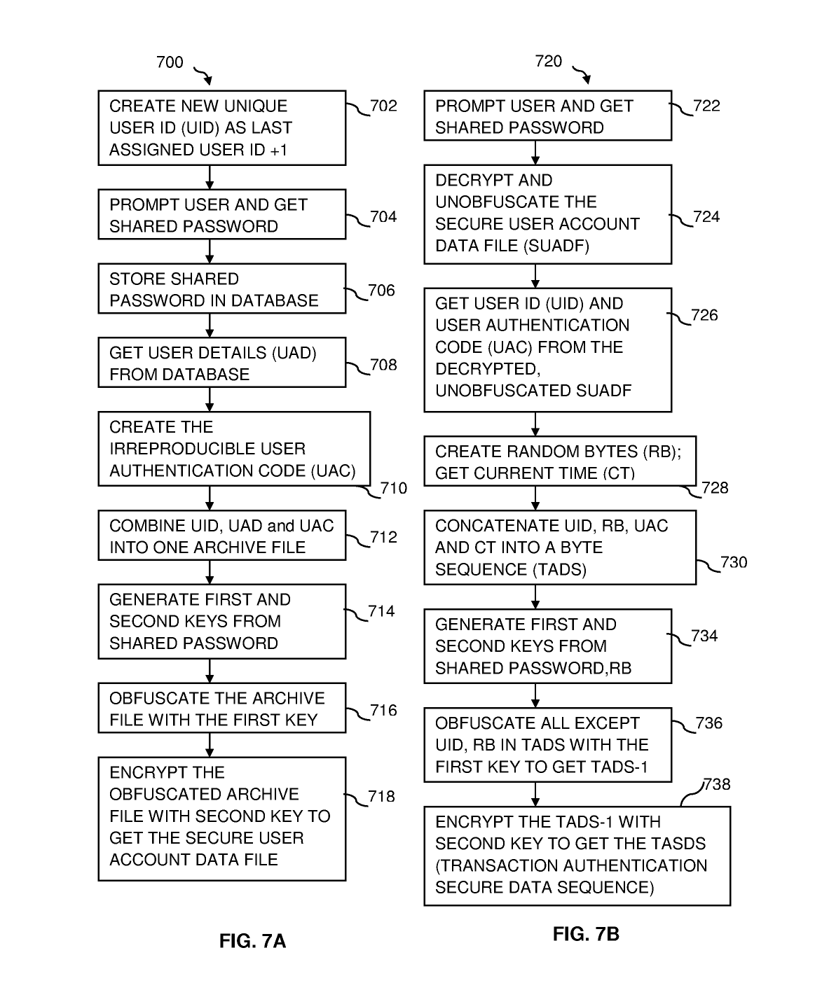

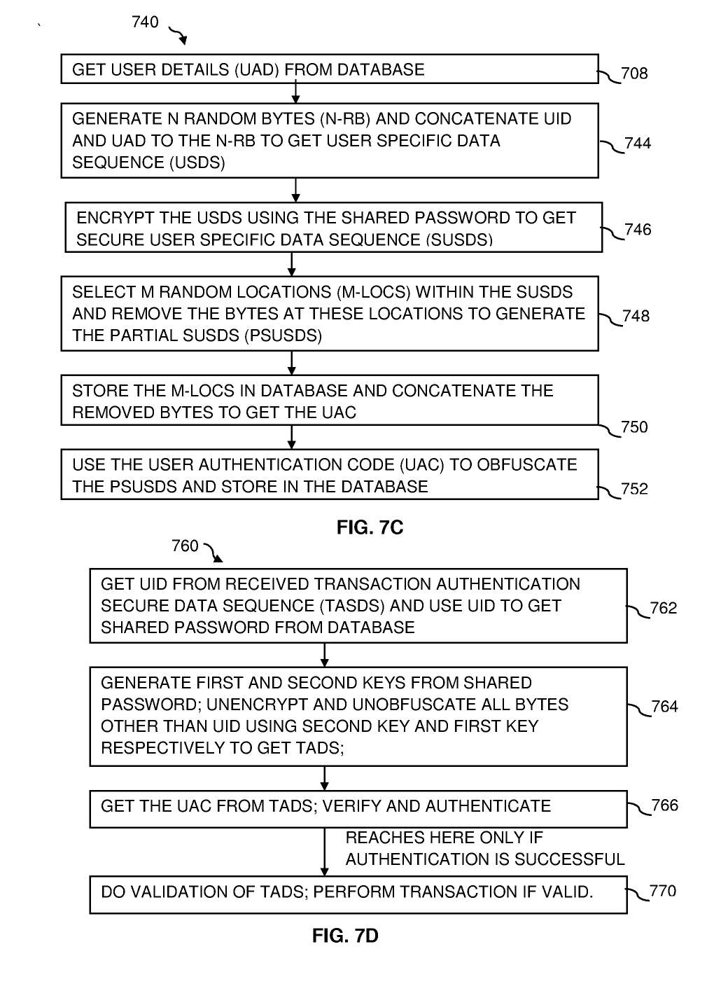

FIG. 4, FIG. 5 and FIG. 6 illustrates more detailed structure of the blocks forming the IAS (350). FIG. 4 illustrates a block diagram of an embodiment (400) of the issuing authority system (IAS) (350). The IAS comprises a transaction processing system (TPS) (185) connected to a database (187) (also referred to as TSP Database or TSP-DB). The TPS (185) is also connected to a data communication system (DCS) (183). A web server (410) is connected to the data communication system (DCS) (183) and the TPS (185).

FIG. 5 illustrates a block diagram of an embodiment of the processing system that is a part of the issuing authority system, virtual wallet system and transaction terminal system. The processing system can have as its components a digital processing unit (510) connecting over a system bus to an encryption accelerator (515), a real time clock (520), a memory system (525), a mass storage system (530) (example: hard disk, removable storage such as memory cards, flash memory etc) and other input/output interfaces (535). Operating system, applications and data (540) are stored in mass storage system (530) and loaded to the memory system (525) for execution. Embodiments can use a microprocessor for the digital processing unit (510). In the case of a user computing device (UCD) being used as a virtual wallet system (315) or a transaction terminal system (325), these components are provided by the hardware and software present in the UCD. The input/output interfaces (535) may support devices such as keyboards, USB interfaces, touch screens, displays etc. If the encryption accelerator (515) hardware is not available/configured, the encryption actions required by the embodiments are performed by custom programming of the digital processing unit (510).

FIG. 6 illustrates a block diagram of an embodiment of the data communication system that is a part of the issuing authority system, virtual wallet system and transaction terminal system. The Data Communication System (DCS) (600) provides the ability to these systems to exchange data between them over a communication network (for example the internet or cellular wireless network). Embodiments may integrate some of the blocks depicted namely wireline modem (610), cellular wireless modem (615), SMS/MMS system (620), IP Router (625), Ethernet/WiFi Interface (630), NFC/wireless (635) and protocol stacks (605). Protocol stacks (605) comprise hardware and/or software for exchanging messages/data between the systems. Any other communication devices/sub-systems may be added to enable data exchange between the the (IAS) (350), VWS (315) and TTS (325) as required in an embodiment and the current set of communication modules shown are for illustration only.

### An Example First Embodiment (FIG. 3, Supporting Figures)—Operation

The example first embodiment and its variations illustrates how secure transactions can be performed.

### Setting Up Virtual Wallet System (VWS) in User Device

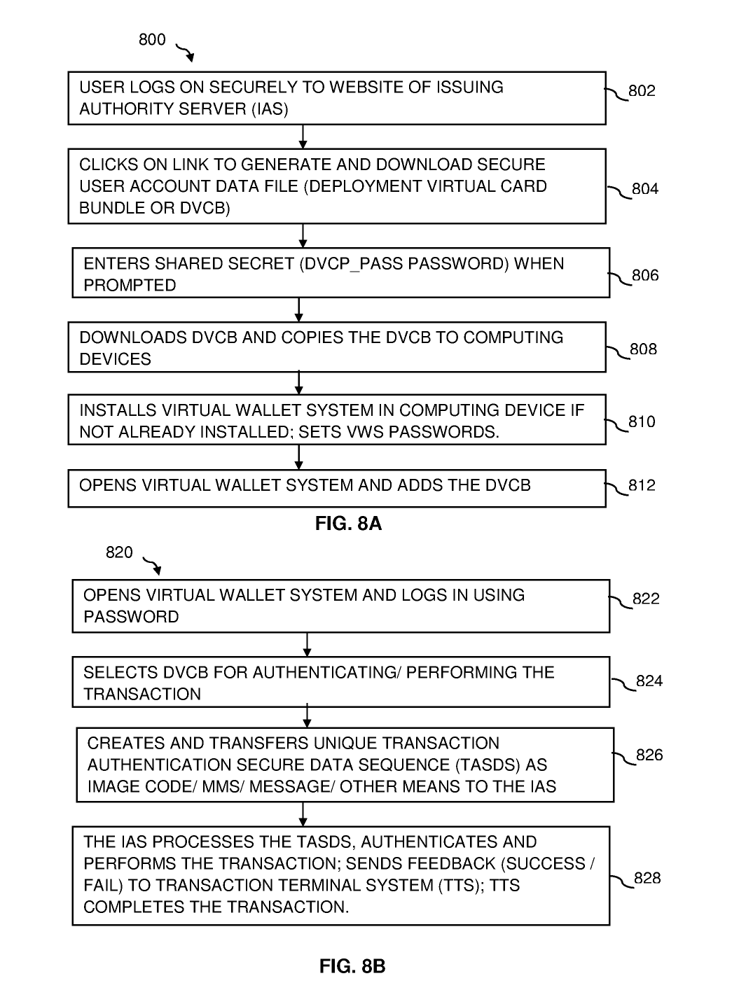

FIG. 8A illustrates an activity diagram of an embodiment of the transaction system wherein the user sets up his virtual wallet system in a computing device. The user performs a secure log in (802) to the website of the TSP, wherein the website is provided by the web server (410) that is part of the IAS (350). The user then clicks on link (804) to generate and download a secure user account data file (further referred as Deployment Virtual Card Bundle or DVCB). The web server (410) prompts (806) the user for a password that is used as a shared secret to secure the data exchanges from the virtual wallet system (VWS) (315) to the IAS (350) while performing transactions. The shared secret is also referred as the DVCB_PASS password. The IAS (350) creates the DVCB and the user downloads (808) the DVCB and copies the DVCB to computing devices in which VWS (315) is needed. The user now installs (810) VWS (315) in computing device if not already installed and supplies two passwords (PASS1 and PASS2) during installation for securing access to the virtual wallet system application (VWSA) (154). The PASS1 password is required to open the (VWSA) (154) for regular operations such as performing transactions and PASS2 is required to enter a privileged mode (PMODE) for performing administrative operations. After installing VWS (315), the user opens the VWSA (154), logs in using PASS1 password, and then enter PMODE using PASS2 password and perform an Add Card (812) operation.

While adding the card, the VWSA (154) prompts the user to enter the DVCB_PASS password that was entered at the TSP's web site while generating the DVCB. Without the correct password, a VWSA (154) program is prevented from using the DVCB and thus security of the same is ensured even if the DVCB file is compromised and falls in the wrong hands. The Add Card operation involves the addition of the DVCB file data into the Database of the VWSA [VWSA-DB] (151) in various modes as described further below. The VWSA-DB (151) is encrypted with sufficient strength using at least the PASS1 password or keys generated from the PASS1 password. While adding the card, the user can provide a nick name for the card for easy identification. This nick name can be used to select the card for use at a TTML.

The VWSA (154) allows two modes of operation for storing the DVCB in the VWSA-DB (151). In Mode-1 [DB-MODE1], the DVCB is kept in its database without decrypting it and the DVCB_PASS password is also not kept in the database. Hence the user has to enter the DVCB_PASS password of the card every time a transaction is performed. In Mode-2 [DB-MODE2], the DVCB is decrypted and re-encrypted with the PASS-1 password and stored in the VWSA database (151) along with the DVCB_PASS which is also encrypted using PASS-1. In this case, the user need not re-enter the DVCB_PASS password for using it as it is available in the database. Embodiments may allow adding some cards using DB-MODE1 (say the more critical cards) and others in DB-MODE2 as the user wishes so that non-critical cards may be used without the need to enter a second password (the DVCB_PASS].

### The Deployment Virtual Card Bundle (Secure User Account Data File)

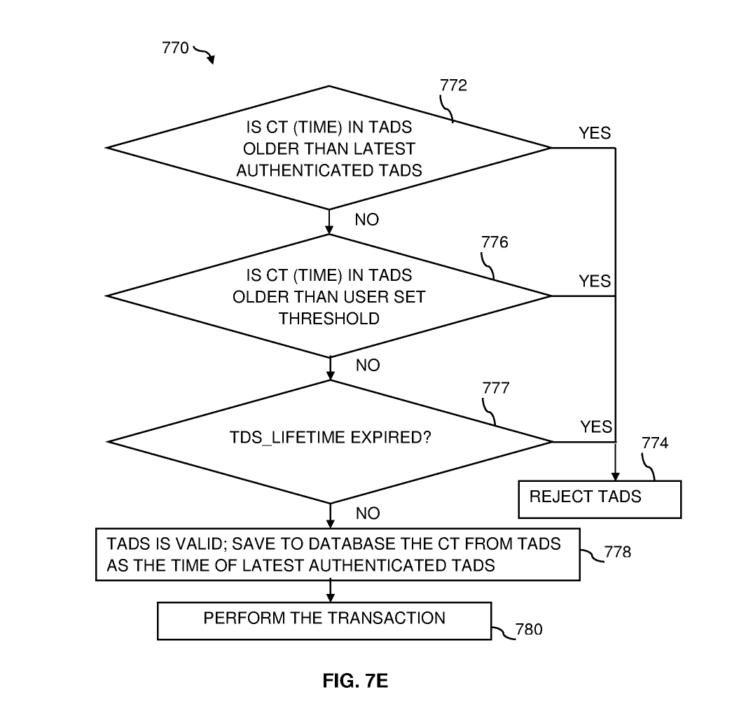

In the embodiments, the secure user account data file (SUADF) also referred to as deployment virtual card bundle [DVCB] is generated by the IAS (350) as shown in FIG. 7A (700) and the DVCB comprises user identification data and corresponding authentication data. A unique user ID (UID) is created (702), say in a serial order of users enrolling by incrementing the last assigned UID by one to use as the user identification data. A part of the UID may also encode the identity of the IAS (350). As described above, the IAS (350) prompts (704) the user to enter a shared secret (password) and store (706) the shared password in the database (187) of the IAS in a secure (say encrypted) manner. The IAS then obtains (708) the information required to identify and authenticate the user as well as all the details pertaining to the Card (the User Account Details (UAD)) from a database (may or may not be the same as IAS database (187). The IAS (350) then creates (710) an user authentication Code (UAC) to use as the corresponding authentication data for the UID. The UAC is created in such a way that it is not possible to reproduce the same UAC using the data maintained in the IAS database. This provides the advantage that a hacker obtaining the data in the database of the IAS (350) is prevented from being able to duplicating the DVCB of the user. The embodiment also provides the advantage of securing the UAD stored in the database (187) of the IAS (350) against hackers. The DVCB created comprises of two sub-bundles, B1 and B2. The B1 bundle comprises of the UAC and the B2 bundle comprises the UID and other user information such as name, account number, photograph etc. B1 and B2 bundle are concatenated (712) into a single archive file called the Virtual Card Bundle (VCB). The IAS (350) then generates (714) two keys (a first DVCB key and a second DVCB key) using any two different standard key generating algorithms from the shared password. The archive file created (VCB) is first obfuscated (716) using the first DVCB key. The obfuscation may be performed in many standard ways, for example by just XOR-ing the bytes of the first key with the bytes in the VCB. The IAS (350) then encrypts (718) the obfuscated VCB to generate the DVCB.

FIG. 7C illustrates the flow chart (740) for an embodiment for the creation of the irreproducible UAC (B1 Bundle). The B1 bundle contains typically eight bytes (may use more or less number of bytes as required based on level of security required) that is named “Jigsaw Bytes”. To obtain the jigsaw bytes, the IAS (350) obtains (708) as mentioned in previous clause the information required to identify and authenticate the user as well as all the details pertaining to the card (the User Account Details (UAD)) from a database. The IAS (350) then generates “N” random bytes (N-RB) and concatenates the UID and the UAD to the N-RB to get a user specific data sequence (USDS). The random bytes ensures a different USDS each time it is created. The IAS (350) then encrypts (746) the USDS using the shared password to get secure user specific data sequence (SUSDS). The SUSDS is further referred as the B1 SEED. The IAS (350) then selects (748) M random locations (M-LOCS) within the B1 SEED (SUSDS) and removes the bytes at these locations to generate the partial SUSDS (PSUSDS). The IAS (350) stores the M-LOCS in database (may be encrypted) and concatenate the removed bytes to get the UAC (B1 Bundle or Jigsaw bytes). The B1 bundle formed in this manner is also called Jigsaw bytes since to recreate the original SUSDS, the jigsaw bytes are placed back in the right positions from where they were removed similar to solving a jigsaw puzzle. The IAS (350) obfuscates the PSUSDS using the UAC (B1 Bundle/Jigsaw Bytes) and stores the obfuscated PSUSDS in the database (187). A one way hash of the Jigsaw Bytes may also be kept in the database (187). The Jigsaw Bytes are not saved in the IAS database (187) and this has the advantage that if there is a data security breach at the IAS (350), the user's DVCB is not compromised.

The B2 bundle comprises of information such as user identification data, a photograph of the User, name of the User, card number and any other information. This information is divided into two categories, C1 and C2. The C1 category shall contain information that is presented and readable by the operator at a Transaction TerMinaL [TTML]. The C2 category shall contain information of a confidential nature, such as the Card Verification Value [CVV] and is not displayed at a TTML, but can be read by the user by entering a special mode called “Privileged Mode” [PMODE] with a separate password (PASS2). This has the advantage of securing/preventing the secret data of a card from being accessed by personnel at a transaction terminal [TTML]. The VCB has a standard extendable format to ensure interoperability with Virtual Wallet System Applications [VWSA] (154) made by different vendors. The format allows flexibility in the data that can be kept in the VCB for different applications. An embodiment may use XML format for the VCB.

A sufficiently strong encryption method for all the encryptions required by the embodiments is the Advanced Encryption Standard [AES] with 128 or 256 bit keys generated from the passwords. Any other encryption methods may be used that provides sufficient security against brute force hacking techniques. Embodiments can use all kinds of methods for generating, storing and transmitting/delivering electronic data files for the purpose of distributing DVCB such as compact disks, DVDs, magnetic tape, solid state drives, compact flash etc. The DVCB cannot be used without having knowledge of the DVCB_PASS password used to generate the same and is hence secure from misuse by other parties. Hence DVCB has the advantage that it may be distributed using an insecure means if the password (shared secret) is secure. The security of the system is not dependent on keeping the application algorithms a secret.

### THE VCB AND DVCB FORMAT (EXAMPLE)

An example of the VCB format would be as follows. The DVCB is formed by obfuscating and encrypting the same using the DVCB_PASS password. The VCB and DVCB is organized as a sequence of bytes. The sequence of bytes can be stored in a computer file. The format is: Byte-1 to 2: Two random numbers; Byte-3 to 4: Length of the VCB; Byte-5 to 12: Creation time of the VCB; Byte-13 to 21: The B1 secure bundle (typically eight bytes), wherein the first byte has the length of this field which is typically 8; Byte-22 onwards: The B2 bundle having other details of the card and consisting of the the C1 and the C2 information as in XML (Extensible Markup Language) format.

### Using the Virtual Wallet System (VWS) to Authenticate and Perform a Transaction

FIG. 8B illustrates an activity diagram (820) of an embodiment of the transaction system wherein the user uses the virtual wallet system (VWS) (315) to perform a transaction. The user opens (822) the VWSA and logs in using password PASS1 and selects (824) the DVCB (SUADF) for authenticating/performing the transaction. The user may enter details of payee and amount and invoke the “perform transaction” action of the VWSA. The VWS (315) creates and transfers (826) a unique transaction authentication secure data sequence (TASDS) also referred to as Secured Transaction Data Frame (STDF) as image code/mms/network message/other means to the IAS (350). The STDF has an extensible format to allow the details of a transaction and any other required data to be added within the STDF in a secure manner. The IAS (350) processes the STDF, authenticates and performs (828) the transaction based on the data in the STDF and sends the feedback (success/fail) to transaction terminal system (TTS) (325). The TTS (325) completes the transaction. Every STDF created has data included in it to ensure that it is unique so that the same STDF cannot be used to perform more than one. An embodiment can use the time of creation of the STDF to create unique STDF data every time the STDF is created and the IAS (350) can reject all STDFs older than the latest previous authenticated STDF.

FIG. 7B illustrates a flow chart (720) of an embodiment of the virtual wallet system (315) for generating a transaction authentication secure data sequence (TASDS) also referred to as Secured Transaction Data Frame (STDF)). The VWSA (154) prompts (722) the user and gets the shared password (DVCB PASS) and uses the shared password to decrypt and unobfuscate (724) the secure user account data file (SUADF). The VWSA (154) gets (726) user ID (UID) and user authentication code (UAC) from the decrypted, unobfuscated SUADF (DVCB). The VWSA (154) then creates (728) random bytes (RB) and reads current time from the system as uses this as the Creation Time (CT) of the DVCB. The VWSA (154) concatenates (730) UID, RB, UAC and CT into a byte sequence (transaction authentication data sequence (TADS), also referred to as Transaction Data Frame (TDF). The VWSA (154) generates (734) a first key from shared password (DVCB_PASS) and a second key from a combination of RB and DVCB_PASS. The VWSA (154) obfuscates (736) all except UID and RB in TADS with the first key to get TADS-1. The VWSA (154) finally encrypts (738) the TADS-1 with second key to get the TASDS (transaction authentication secure data sequence)/Secured Transaction Data Frame (STDF). The TDF in some embodiments may contain more details of the transaction such as payee, amount etc. Some embodiments generate a hash or CRC computed over the entire TDF and places it within the part of the TDF that is obfuscated and encrypted to enable verification of the integrity of the unsecured (unencrypted) data in the TDF. The IAS (350) recomputes the CRC/hash value over the received TDF and compares with the value in the TDF for verifying the integrity of the data, especially the unsecured part. Embodiments enable protection against brute force hacking by obfuscating the encrypted part of the TDF (i.e. after the encryption) using an obfuscation key provided by the IAS (350) within the DVCB.

### Authenticating the STDF (TASDS) at IAS and Performing the Transaction

FIG. 7D illustrates a flow chart (760) of an embodiment of the issuing authority system (350) for authenticating and performing a transaction. The IAS (350) obtains (762) UID from the transaction authentication secure data sequence (TASDS) received from the user device (example: VWS (315)) and uses the UID present in the TASDS as a key to get shared password (DVCB_PASS) from the database (187). The IAS (350) then generates (764) first and second keys from shared password and decrypts the encrypted part of the TASDS (i.e. all bytes except the UID) using the second key. In the next step, the IAS (350) unobfuscates the decrypted part of the TASDS using the first key to get back the TADS created at the user device. The IAS (350) gets (766) the UAC from TADS, authenticates the UAC and finally verify (770) the TADS for validity. If the TADS is valid, the transaction is performed and feedback send to the transaction terminal system (325). The TADS is invalid if it is not received for the first time (a duplicate is received) or if the life time of the TADS is expired or if the CT present in the TADS has a time earlier than a user set value or the time (CT) of the last authenticated, valid transaction.

The authentication follows the reverse operations performed in FIG. 7C. The IAS (350) gets the obfuscated PSUSDS from the IAS database (187). The IAS (350) uses the UAC (got from TADS) obtained in step (766) to unobfuscate the obfuscated PSUSDS. The IAS (350) gets the M-LOCS from the IAS database (187) and reinstate (insert) the removed bytes at the locations specified by M-LOCS to get back the SUSDS. Remember that the removed bytes form the UAC, and hence these bytes are available for the authentication process. The IAS (350) then decrypts the SUSDS to get the USDS. Now the IAS (350) verifies the data, say by comparing the UID in the USDS against the UID in the TADS for equality. The authentication succeeds if the UID in the USDS and the UID in the TADS are equal.

FIG. 7E illustrates a flow chart (770) of an embodiment of the issuing authority system (350) for validating the transaction authentication data sequence. Embodiments provide a high level of security by ensuring that the generated TDF is considered valid only for a short duration of time after its generation which is referred to as the TDF Life Time. [TDF_LIFETIME]. The IAS (350) checks (772) if the CT (creation time) in TADS is older than the latest authenticated TADS and rejects/aborts (774) the transaction if it is older than the latest authenticated TADS. The IAS (350) checks (776) if the CT (time) in TADS is older than user set threshold and rejects/aborts (774) the transaction if it is older than the user set threshold. The IAS (350) checks (777) if the TDF_LIFETIME has expired based on the CT (time) and TDF_LIFETIME in TADS and rejects/aborts (774) the transaction if the life time has expired. If the TADS is not rejected by the above steps, the TADF is valid and the IAS (350) saves to the database (187) the CT from received TADS as the time of latest authenticated TADS and then performs (780) the transaction.

A number of security features are provided by some or all of the embodiments. Embodiments can provide the user a facility to set a time threshold to invalidate all TDFs generated prior to the threshold time. Embodiments can also provide the user a facility to configure the TDF_LIFETIME as part of the TDF data. Another security feature of some embodiments provide the user with a facility to enter a maximum amount for the transaction so that the IAS (350) validates the transaction only if the amount of the transaction is equal or less than the maximum amount specified in the TDF. Similarly, the user can specify a temporary PIN within the TDF that is valid only for that TDF. The IAS (350) rejects the transaction if the PIN entered by the user at the transaction terminal is not the same as the temporary PIN.

### THE TDF AND STDF FORMAT (EXAMPLE)

The TDF is a sequence of bytes providing user identification data, user authentication data, creation time (CT) and other details of the transaction. STDF is a secured form of the TDF wherein a part or all of the TDF is obfuscated and encrypted using the DVCB_PASS password. The TDF is sub-divided into smaller bit sequence fields having the required information about the transaction. The higher significant bit/nibble/byte shall occur first in a sequence defining a value of multiple bits/nibbles/bytes and is numbered from 1 upwards till 4 in a nibble, 1 to 8 in a byte and bytes are numbered starting with 1. The main function performed by the TDF is to authenticate the transaction as being done by the bonafide User. The TDF may also optionally contain the details of the payee, the amount/maximum amount allowed for this transaction. When the TDF is generated by a TTS (325), the TDF can also include another STDF generated by the end user VWS (315) and transferred by any means to the TTS (325).

The following gives an example format for the TDF that is flexible for adding more data as required by the transaction. In this example format, the sequence of bytes starts with an unsecured part that is not encrypted in the STDF and is followed by a secured part that is encrypted in the STDF. The secured part can optionally be followed by another unsecured part.

The format is: Byte-1: First three bits (bits 1 to 3): Version of TDF format, is 000b for initial version. Last five bits (bits 4 to 8): Type of TDF is 00001b for financial transaction without PIN and 00010b for financial transaction with PIN in use; Byte-2: This byte can extend the information in the first byte if any of the two fields in the first byte is all ones. Otherwise, it gives the length of the secure part of the STDF in blocks, where each block is 8 bytes. The length of the secure part of STDF is always a multiple of 8 bytes. If the first two bits of this byte are both ones, then these bits must be ignored and the length is present in the remaining bits of this byte and the entire next byte; Byte-3: This byte has its bits defined to specify any required information about the TDF in future such as encryption method used etc. This is 0x00 at present. If its bit-1 is 1, then it extends into the next byte. Byte-4: If length is not extended into this byte, a 8 byte hexadecimal value identifying the User/User's card (UID) is kept here in bytes 4 to 11; Byte-12-15: In the STDF, the bytes starting with this byte and including this byte till the two bytes that holds a CRC (included) is encrypted and is referred as the Critical Data of the TDF. Four bytes of random numbers are kept here to ensure that the encrypted data is not the same even when all other data remains the same. These random bytes are also used along with the DVCB_PASS for creating the key for obfuscating the secured part other than these random bytes. Byte-16-23: The B1 bundle (formed with the Jigsaw Bytes) that has typically 8 bytes. This and the UID is used by the IAS (350) to authenticate the user; Byte-24-28: Five bytes are used to keep the time in number of hundred milli-second intervals past the Epoch. It is also possible to define more bytes to keep a more precise time value. Byte-29: Keeps the TDF_LIFETIME selection in minutes; Byte-30: Bit 1 denotes whether the amount of the transaction follows this byte. Bit-2 denotes whether the amount (if present) is the maximum amount or the actual amount for the transaction. Bit-3 denotes whether payee details follow the amount below. Bit-4 denotes whether another end user STDF is appended. Bit-5 to 8 are reserved for future use and is 0 at present; Byte-31-34: Four bytes are used to keep the amount/maximum amount with two fixed decimal points to allow specifying up to approximately 42.9 million; Byte-35-36: Cyclic Redundancy Check (CRC) bytes (unless another STDF is appended—else the appended STDF is kept here)—Two bytes are used. CRC-16-CCITT specified by the ITU (International Telecommunication Union) over the entire TDF before any encryption is done and keeping these bytes as zeros. This approach in embodiments ensures that any tampering of the unencrypted portion of the STDF is detected as the CRC is kept within the secured encrypted part.

The STDF is formed from the TDF as follows: The byte sequence starting from Byte-16 (the B1 bundle start location) till Byte-36 (or the last CRC byte where ever it occurs), are obfuscated using a key generated using the DVCB_PASS password and the random bytes in byte-12 to 15. Then the bytes including and starting with the random bytes and ending with and including the CRC bytes are encrypted by AES-256 encryption using keys generated from the DVCB_PASS password. An embodiment may also further obfuscate the encrypted part using an obfuscation key provided by the IAS (350) within the DVCB to protect against brute force attacks on the encryption. The embodiment keeps a small part of the information that is non-critical to security of the transaction in an un-encrypted form to enable the decrypting system to identify the user and locate the corresponding information stored at its end such as the password to be used for decrypting.

When more details are added such as payee details to be present in unsecure form, the format can be expanded to include these after the secured part. The secured part can also be expanded to keep more information based on requirements.

### Implementing the TDF_LIFETIME

Embodiments may implement this in any way and is not meant to use very accurate or precise clocks. It is required to have the User Device clock to be set to the approximate local time and the time zone be known so that the VWSA has the current time in UTC (Universal Time Coordinate) available. A simple way to implement the life time is to keep the time value in tens of seconds since an Epoch (say midnight, Jan. 1, 1970 as used in most User Devices) within the TDF. The user may also configure different TDF_LIFETIME options, say in the range of 1 to 240 minutes. The time value at the instant when the TDF is created (TDF_TIME or CT) kept within the TDF along with a byte denoting the selected TDF_LIFETIME in minutes. The IAS (350) as part of its processing verifys that the TDF_TIME is valid and the TDF_LIFETIME selected has not expired. Since most User Devices can be made to synchronize their clock to an accurate network time source, the time on the User Device is expected to be fairly accurate. The IAS (350) also provides in its processing algorithms enough tolerance for the User Device clock to be slow or fast by an appropriate number of seconds for enhanced reliability. The VWSA has a user interface to check its time with a IAS (350) clock and synchronize the User Device clock with the same if required using SMS and/or internet communication.

### Implementing a Transaction Terminal System Using DVCB

An embodiment allows identification and authentication of the TTS (325) using the DVCB. In this embodiment, the IAS (350) issues a DVCB enabled to perform as a TTS (325). One embodiment has a transaction terminal system application (TTSA) similar to the VWSA for creating STDF based on a DVCB provided by the IAS (350). The DVCB issued for a TTS (325) essentially identifies the owner/operator of the transaction terminal. This enables user computing devices to function as a TTS (325/325A) without specialised expensive hardware. The TTS(325) includes all the data of a transaction including the STDF from an end user VWS (315) in the STDF generated for the transaction. Another similar embodiment can integrate the TTSA with in the VWSA (154) so that both functionalities are provided to the user in a single system.

An embodiment enables an end user to receive payments from another end user. In this case, the TTS (325) is integrated in the VWS (315) of the payee. The payee opens the VWSA (154) and selects receive payment option and enters the amount to be received. The TTS (325) creates the STDF comprising of payee name, payee UID, IAS (350) identification code in the unencrypted portion of the STDF. The encrypted part of STDF has authentication data. The STDF is transferred to the payer by any means. The payer uses his VWSA (154) to select the payee STDF file upon which VWSA (154) displays the payee details for verification. The payer enters the amount to be paid and confirms the transaction upon which the VWSA (154) of the payer creates an STDF and transfers it to the IAS (350) of the payer to authenticate and perform the transaction. The STDF created by the payer's VWSA (154) comprises of the entire payee STDF and the payer's authentication data (UID, UAC, CT etc as described earlier). The IAS (350) of the payer authenticates the payer and transfers the payee's STDF to the IAS (350) of the payee along with payment instructions. The IAS (350) of the payee authenticates the payee, performs the transaction if authentication is successful and reports the status to the payer's IAS (350). The concepts of this embodiment also enables an STDF or STDIF (130) to be made available in invoices/bills wherein the invoices/bills may be in electronic document (say a PDF format file) or printed on paper. The STDF data comprises of the payee details and the amount of the transaction. In an electronic document, the STDF is presented as a link (say in pay://format) whereby the user clicks on the link to invoke the VWSA (154) and perform payment. The invoices/bills in any format can have STDIF image (say a QR code) defining the payment details. The payer's VWSA (154) acquires the STDIF using the camera on the user computing device to obtain the details of the transaction and performing the transaction.

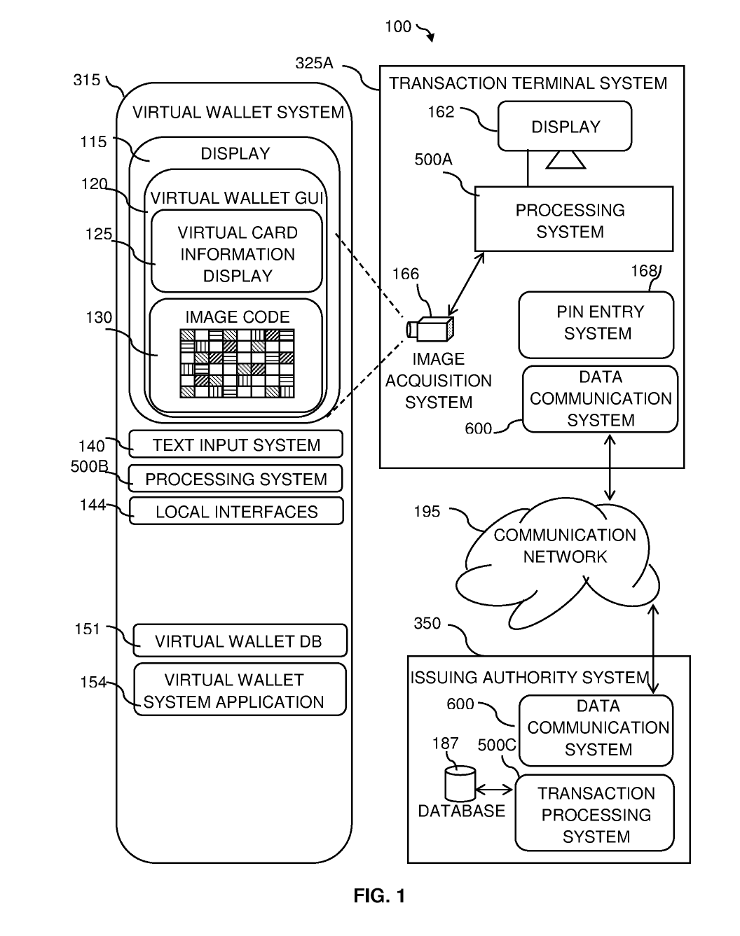

### Example Second Embodiment (FIG. 1)—Structure

FIG. 1 illustrates a block diagram (100) of an embodiment of the transaction system for allowing the end user to perform secure transaction using virtual wallet at a transaction terminal. It comprises of an IAS (350), VWS (315) and a TTS (325A). The difference from the example first embodiment is that the VWS (315) and TTS (325A) is now configured to allow communication of the STDF as a coded image from the VWS (315) to the TTS (325A). For this the TTS (325A) comprises an image acquisition system (166) connected to the Processing System (500A) integrated in the TTS (325A). The TTS (325A) also comprises a DCS (600), a PIN entry system (168) (may use a mechanical keypad), and a display (162) connected to the Processing System (500A). The VWS (315) comprises a display (115), a text input system (140), local interfaces (144), and virtual wallet DB (Virtual Wallet System Application Database or VWSA-DB) (151) connected to the Processing System (500B). The VWS (315) also comprises of a Virtual Wallet System Application (VWSA) (154) that provides a Graphical User Interface (GUI) (Virtual Wallet GUI (120)). The (VWSA) (154) executes on the digital processor and allied hardware provided in the Processing System (500B). The (VWSA) (154) displays the virtual card information (125) and image code (130) (STDF coded as an image, say using barcode) on the Virtual Wallet GUI (120). The virtual card information (125) comprises user name, photograph of the user etc. The TTS (325A) and IAS (350) are connected to each other over a communication network (195). The structure of the IAS (350) is similar to that in the example first embodiment.

### Example Second Embodiment (FIG. 1)—Operation

This embodiment operates similar to the example first embodiment. The user opens the VWSA (154) in the VWS (315), logs in using the PASS1 password and selects a card from the list of card nick names shown on the screen. The VWSA (154) shows the card details on the display (115). This can include details like the user's name, the card number or part of it, the validity period, the TSP,s trade marks/logos and the user's photograph. A coded image which encodes the STDF (say in a Bar Code/QR Code or other image coding schemes) is shown on the screen. The coded image is further referred to as Secure Transaction Data Image Frame (STDIF). The TTS (325A) acquires the STDIF (130) through its image acquisition system (166) and decodes the image to obtain the STDF. The TTS (325A) transfers the STDF along with other transaction details such as amount to the IAS (350). The user may be required to enter a PIN if the IAS (350) requires the same. The transaction is authenticated and completed as explained in example first embodiment.

This embodiment enables the user to perform a transaction at a Transaction Terminal through a third party where in the user not present at the TTML. The third party requires a User Device that has MMS, email or similar facility that can receive an image from the User. In this case, the third party communicates the amount of the transaction to the User via a telephone, SMS or other similar means. The user uses the VWSA (154) GUI to configure the maximum amount and temporary PIN while creating the STDIF (130). The STDIF (130) can then be transferred by email, MMS, ftp and such techniques, optionally in compressed form, to the third party's User Device. The user communicates the transaction specific PIN to the third party through any means (for example, over telephone). The third party displays the image on the User Device for acquisition by the transaction terminal system (325A) and processing as described earlier.

In another embodiment, the transaction terminal system (325A) can reside on a mobile phone or such computing device to enable the user to perform transactions and accept payments from end users. This enables the user (say a small merchant or door to door sales persons) to operate a secure TTS (325A) without having to invest in expensive specialised hardware. The camera on the User Computing Device acquires the STDIF from the payer's VWS (315). The embodiment advantageously communicates to the IAS (350) over the internet or cellular wireless network. Transactions can even be performed with the use of just SMS/MMS for transferring the STDF to the IAS (350).

Some embodiments enables access control, membership cards, identity cards, gift coupons, vouchers, driving license etc., wherein the STDF/STDIF (130) is used for authenticating the user. In an embodiment to enable identity verification, the VWSA (154) displays the user's name, photograph and any other details along with a STDIF (130). The verifier uses a TTS (325A) that acquires the STDIF (130) from the screen of the User Device. The TTS (325A) transfers the STDF to the IAS (350). The IAS (350) sends the details of the authenticated user including identification photograph to the TTS (325A) where it is shown on the display (162) for verification.

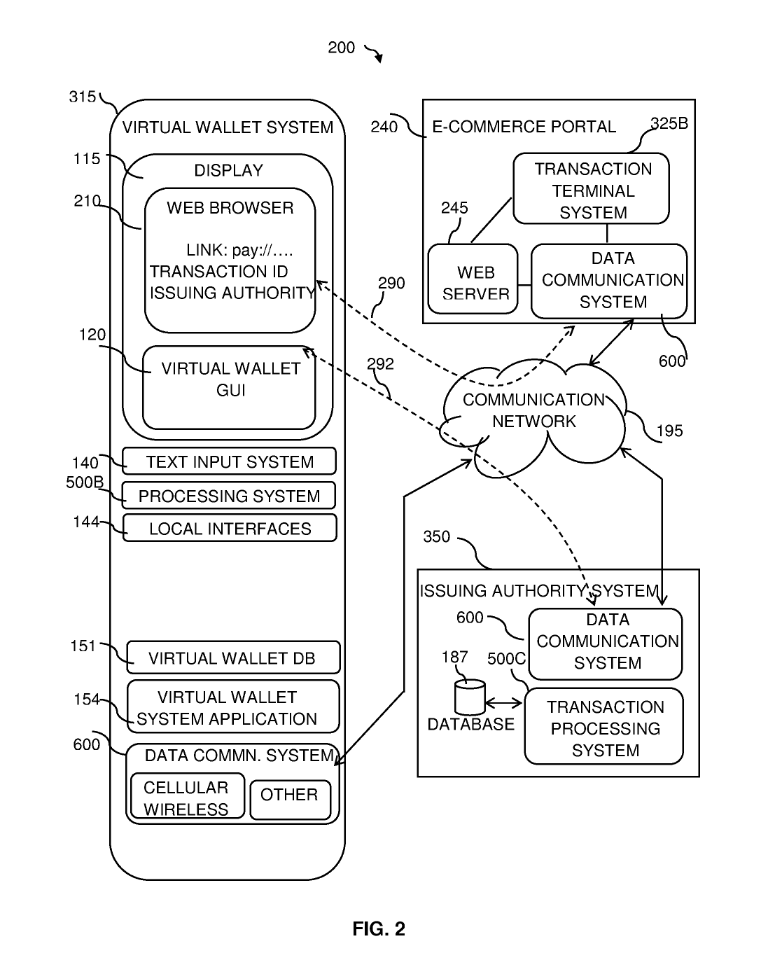

### Example Third Embodiment (FIG. 2)—Structure

FIG. 2 illustrates a block diagram (200) of an embodiment of the transaction system for allowing the end user to perform secure online (Internet) transaction using virtual wallet. The structure of the system is similar to the example second embodiment except for the differences cited here. In this embodiment the VWS (315) also includes a web browser (210). The TTS (325B) is integrated within an e-commerce portal (240). The TTS (325B) is also connected to a web server (245). The web server (245) and the TTS (325B) are connected to DCS (600). The VWS (315) also includes a DCS (600) using which it can communicate (292) with the IAS (350). The DCS (600) of each of the systems (TTS (325B), VWS (315), and IAS (350) are connected to communication network (195).

### Example Third Embodiment (FIG. 2)—Operation

A number of embodiments support transactions on the internet or other networks. The payee website/portal (240) provides a Universal Resource Locator [URL] (link) on the web page for effecting the transaction after the user has selected the TSP and has agreed on the amount of the transaction. Before presenting the URL, the payee web server would have connected to the IAS (350) based on the selected TSP and performed a transaction request and obtained a Transaction ID [TR_ID] for the proposed transaction. The IAS (350) stores the transaction details and related TR_ID in its database (187). When the user clicks on the URL, all the data required for the transaction such as payee name and account number along with the TR_ID is provided to the VWSA (154) during its invocation as supported by the Operating System in the form of a Command Parameter, an Environment Variable or other inter-process communication means.

An embodiment may use a new type of URL say, starting with “pay://” (without the starting and ending double quotes) to pass the information while using standard URL format defined by the Internet Engineering Task Force [IETF] for the rest of the URL. The VWSA (154) creates a STDF which also includes the TR_ID and pass this to the IAS (350) using any means such as internet, SMS, MMS or even a voice circuit (telephone call). The address/contact details of the IAS is pre-defined in the DVCB or configured by the user. The TR_ID and other payee details is placed within the encrypted (secured) part of the STDF for securing the same against hackers. An embodiment may encode the STDF in MIME (Multipurpose Internet Mail Extensions) format and pass it in the Body of a POST request using the HTTP (Hyper Text Transfer Protocol) for transferring the STDF to the IAS (350). The IAS (350) on obtaining the STDF compares the TR_ID and payee details against the data stored in the IAS database (187) and performs the transaction if the comparison matches. The IAS (350) can automatically provide an update to the payee web server on the success/failure status OR the payee web server can poll the IAS (350) to obtain the same and complete the transaction accordingly.

An embodiment can enable the user to verify the payee identity corresponding to the TR_ID before confirming the transaction. In this case the VWSA (154) communicates the TR_ID to the IAS (350) and the IAS (350) returns the details of the transaction such as payee identity, amount etc. The details are then displayed by the VWSA (154).

An embodiment enables an user to complete a transaction initiated using the internet by a third party on behalf of the User or otherwise. In this method, the third party performs the transaction on the payee's web page and obtains the URL described above. The URL is then transferred over a standard messaging channel such as email, chat etc to the User. The user clicks on the URL and perform the transaction as described above. An embodiment enables the user to copy and paste the URL into the Virtual Wallet GUI (120) and perfrom the transaction. The embodiments described herein are extremely secure as no information is passed on to the payee web site and the transaction is performed by the VWSA (154) directly connecting with the IAS (180). An example format for the URL is “pay://<IAS Internet Host>.<IAS Internet Domain Name>[:<port>]/<IAS Payment Page Path>/?payee=<Payee Name>&payee_account=<Payee Account Number>&trid=<Transaction ID>&amount=<Amount>&currency=<Currency Code>, where, the double quotes are not part of the URL and the items enclosed within the angle brackets < > and including the brackets are replaced with the actual value of the item.

In another embodiment, the only data required for the user to make a payment is the TR_ID alone, wherein the TR_ID has the encoded details of the issuing authority that issued the TR_ID. The payer's IAS (350) obtains the identity of the payee's IAS (350) from the encoded details in the TR_ID and communicates with the the payee's IAS (350) to complete the transaction.

The foregoing description of the embodiments of the invention has been presented for the purposes of illustration and description. It is not intended to be exhaustive or to limit the invention to the precise form disclosed. Many modifications and variations are possible in the light of the above invention. It is intended that the scope of the invention be limited not by this detailed description, but rather by the claims appended hereto.

We claim:

1. A secure transaction system for enabling transactions using any computing device comprising:
a) an issuing authority system:
I. to generate a user account data file containing at least user identification data and corresponding authentication data;
II. to generate a secure user account data file by encrypting the user account data file using a shared secret between the issuing authority system and the user;
III. to transfer to one or more computing devices using any means the secure user account data file that is required at the computing device to create a transaction authentication secure data sequence;
IV. to receive over any communication channel and process the transactions generated by a transaction terminal system;
V. to receive over any communication channel the transaction authentication secure data sequence created at the computing device;
VI. to authenticate the received transaction authentication secure data sequence only the first time the particular transaction authentication secure data sequence is received by the said issuing authority system; and
VII. to inform the transaction terminal system of at least the status of success or failure of the transaction;
b) a virtual wallet system deployed in an end user computing device:
I. to store one or more said secure user account data file obtained from the issuing authority system;
II. to use the stored secure user account data file for creating a transaction authentication data sequence comprising at least the information sufficient to enable the issuing authority system to perform authentication wherein the transaction authentication data sequence created is different and unique each and every time;
III. to encrypt the created transaction authentication data sequence, by utilizing at least the shared secret between the issuing authority system and the user to generate the transaction authentication secure data sequence; and
IV. to transfer the generated transaction authentication secure data sequence using any means to the issuing authority server for authenticating a transaction;
c) a transaction terminal system:
i. to create one or more transactions and communicate at least the created one or more transactions to the issuing authority system by any means wherein the created one or more transactions are operations that require authentication of the user.

2. The system as claimed in claim 1, wherein a life time is imposed on the said transaction authentication secure data sequence and the issuing authority system performs authentication only within the lifetime of the transaction authentication secure data sequence.

3. The system as claimed in claim 1, wherein the issuing authority system performs authentication only if a reference time of the transaction authentication secure data sequence received is later than the reference time of a previously received, successfully authenticated said transaction authentication secure data sequence.

4. The system as claimed in claim 1, wherein the user is allowed to set a rejection time threshold and the issuing authority system rejects all the received said transaction authentication secure data sequences having the reference time of the transaction authentication secure data sequence older than the set rejection time threshold.

5. The system as claimed in claim 1, wherein:
a) the virtual wallet system is configured:
I. to encode the transaction authentication secure data sequence to generate a coded image; and
II. to display at least the coded image on a display screen;
b) the transaction terminal system is configured:
I. to capture the coded image using an image acquisition system;
II. to decode the captured image to obtain the transaction authentication secure data sequence or a representation of the same;
III. to transmit over any communication channel the transaction authentication secure data sequence or a representation of the same along with other details of the transaction to the issuing authority system for authenticating and performing the transaction;
IV. to receive the status of the authentication/transaction from the issuing authority system; and
V. to perform activities required to complete the transaction based on the received status from the issuing authority system;
c) the issuing authority system is configured to accept from the transaction terminal system the transaction authentication secure data sequence or a representation of the transaction authentication secure data sequence in addition to the transaction details for authentication of the transaction, performing the transaction if the authentication succeeds and then informing the transaction terminal system of at least the status of success or failure of the transaction.

6. The system as claimed in claim 5, wherein the coded image created is transferred by any means to a computing device of a third party to enable the third party to perform a transaction at the said transaction terminal system.

7. The system as claimed in claim 5, wherein the end user specifies a transaction specific temporary personal identification number/password as part of the transaction authentication secure data sequence created.

8. The system as claimed in claim 1, wherein the user also specifies a maximum amount for the transaction as part of the transaction authentication secure data sequence created.

9. The system as claimed in claim 1 is configured to enable the transaction terminal system to authenticate with the issuing authority system and perform a transaction wherein:
a) the transaction terminal system is configured:
I. to store one or more said secure user account data file obtained from the issuing authority system;
II. to use the stored secure user account data file for creating a transaction authentication data sequence comprising at least the information sufficient to enable the issuing authority system to perform authentication wherein the transaction authentication data sequence created is different and unique each and every time;
III. to encrypt the created transaction authentication data sequence, by utilizing at least the shared secret between the issuing authority system and the user to generate the transaction authentication secure data sequence; and
IV. to transfer the generated said transaction authentication secure data sequence using any means to the issuing authority server for authenticating a transaction.

10. The system as claimed in claim 9, wherein the transaction terminal system is integrated within the virtual wallet system so as to enable the end user to create and perform the transaction.

11. The system as claimed in claim 1, wherein the virtual wallet system is configured:
a) to obtain by any means the details of the transaction created by the transaction terminal system; and
b) to send by any means to the issuing authority system after including the details of the transaction within the transaction authentication secure data sequence, wherein, the details of the transaction comprises information related to identity of the particular transaction terminal system and other particulars unambiguously defining the transaction.

12. The system as claimed in claim 1, wherein:
a) the transaction terminal system is configured to create a transaction and communicate the details of the transaction to the issuing authority system;
b) the issuing authority system is configured to create a unique transaction identifier for the transaction and transfer the unique transaction identifier to the transaction terminal using any communication channel;
c) the virtual wallet system is configured to include the transaction identifier in the created transaction authentication secure data sequence and transfer the created transaction authentication secure data sequence to the issuing authority system; and
d) the issuing authority system is configured to authenticate the transaction based on the transaction authentication secure data sequence and perform the transaction based on the transaction identifier obtained from the transaction authentication secure data sequence.

13. The system as claimed in claim 12, wherein the virtual wallet system communicates the transaction identifier to the issuing authority system for obtaining the details of the transaction and displays the obtained details of the transaction to the end user for verification before the transaction is performed.

14. The system as claimed in claim 12, wherein the system is configured to enable payment on websites using a web browser deployed on the end user computing device wherein:
a) the transaction terminal is integrated with the website system; and
b) the transaction terminal displays the transaction information as a link on the webpage wherein clicking on the link by the end user invokes the virtual wallet system and transfers the link to the virtual wallet system so as to use the data in the link to perform the transaction.

15. The system as claimed in claim 5, wherein:
a) the issuing authority on successful authentication of the transaction authentication secure data sequence transfers the end user identity data to the transaction terminal; and
b) the transaction terminal is configured to display the received end user identity data so as to enable the identity verification of the end user.

16. The system as claimed in claim 1, wherein the issuing authority system is configured:
to generate an user authentication code as the corresponding authentication data wherein the generated user authentication code is irreproducible later.

17. The system as claimed in claim 1, wherein:
a) the computing device is configured
I. to generate a random obfuscation key each time the transaction authentication secure data sequence is generated;
II. to obfuscate part of the transaction authentication data sequence using the generated random obfuscation key;
III. to encrypt part of the transaction authenticated data sequence, wherein the part encrypted comprises the obfuscated part of the transaction authentication data sequence;
IV. to provide within the encrypted part of the transaction authentication data sequence the information required by the issuing authority system to generate the random obfuscation key for reversing the obfuscation;
b) the issuing authority system is configured:
I. to decrypt the encrypted part of the transaction authentication secure data sequence; and
II. to generate the random obfuscation key and reverse the obfuscation to obtain the transaction authentication data sequence; and
ii. to perform authentication based on the obtained transaction authentication data sequence
thereby protecting the encrypted part of the transaction authentication secure data sequence against any security attacks.

18. The system as claimed in claim 1, wherein:
a) the issuing authority system generates and places a random obfuscation sequence within the said user account data file; and
b) the computing device generating the transaction authentication secure data sequence uses the said obfuscation sequence to obfuscate the encrypted parts of the said transaction authentication data sequence;
thereby protecting the encrypted part of the transaction authentication secure data sequence against any security attacks.

19. The system as claimed in claim 1, wherein the system validates the integrity of the unencrypted part of the transaction authentication data sequence wherein:
a) the computing device generating the transaction authentication data sequence computes a verification code on at least the unencrypted part of the transaction authentication data sequence;
b) the computed verification code is placed within the encrypted part of the transaction authentication secure data sequence; and
c) the issuing authority system computes the verification code and validates the integrity by comparing the computed code against the verification code in the transaction authentication data sequence.

20. The system as claimed in claim 16, wherein the issuing authority system is configured:
a) to generate a random data sequence;
b) to create a user specific data sequence comprising of the generated random data sequence and user specific information;
c) to encrypt the user specific data sequence to generate the secure user specific data sequence;
d) to discard the generated random data sequence;
e) to remove random parts of the said secure user specific data sequence to generate a partial secure user specific data sequence and combine the removed random parts to generate the user authentication code;
f) to obfuscate at least the partial secure user specific data sequence using the removed random parts and store the obfuscated partial secure user specific data sequence in the database of the issuing authority system;
g) to store in the database of the issuing authority system the locations from where the random parts were removed; and
h) to authenticate the received transaction authentication secure data sequence by:
I. obtaining the user authentication code from the received transaction authentication secure data sequence;
II. obtaining the locations from where the said random parts were removed from the issuing authority system database;
III. obtaining the obfuscated partial secure user specific data sequence from the database;
IV. reversing the obfuscation using the user authentication code from the received transaction authentication secure data sequence;
V. reinstating the removed random parts to the locations from where the said random parts were removed to obtain the secure user specific data sequence; and
VI. decrypting the obtained secure user specific data sequence to obtain the user specific data sequence;
thereby creating irreproducible said user authentication code and also protecting the user specific data against any security attacks.
